(19) United States
(12) Patent Application Publication
(10) Pub. No.: US 2006/0032065 A1
(43) Pub. Date: Feb. 16, 2006

(54) Kwik leads

(76) Inventor: Stephen E. Howell, Gastonia, NC (US)

Correspondence Address: Stephen E. Howell, 2324 Loch Stone Drive, Gastonia, NC, 28054, US

(21) Appl. No.: 11/088,624

(22) Filed: Mar. 24, 2005

Related U.S. Application Data
(60) Provisional application No. 60/556,791, filed on Mar. 29, 2004.

(51) Int. Cl. B43L 13/00

(52) U.S. Cl. 33/404

(57) ABSTRACT

The Kwik Leads will enable the ease of brick laying and improve the quality in the manufacture of homes and commercial buildings. The inventive device includes several pieces of various metals that are drilled, tapped, and slotted. With a handle used to hold the tool. 3″ by 0.500 by 1″ aluminum block which connects the scale to the adjustment bracket. 0.250 by 3.500″ by 7.250″ plate. 0.250 by 3.500 by 16.00″ plate.

### BACKGROUND OF THE INVENTION

Brick laying in general has been in use for years. Typically, brick laying is comprised of Line of Sight.

The main problem with conventional brick laying is there are no tools of this nature. The work performed without this tool takes approximately two to three times longer with inferior quality results. Another problem with conventional brick laying is additional manpower required. Also, with conventional brick laying the quality of the job using the line of sight method can produce unacceptable results.

In this respect, the Kwik Leads according to the present invention substantially departs from the conventional concepts and designs of the prior art, and in so doing provides an apparatus primarily developed for the purpose of ease of brick laying and improved quality in the manufacture of homes and commercial buildings.

### SUMMARY OF THE INVENTION

A primary object of the present invention is to provide a Kwik Leads that will overcome the shortcomings of the prior art devices.

Other objects are to provide a Kwik Leads that simplifies masonry work, improves quality of work, makes subsequent jobs become easier and the tool is simple to maintain and operate. Also, to provide a tool that is light weight and durable.

It is to be understood that the invention is not limited in its application to the details of construction and to the arrangements of the components set forth in the description or illustrated in the drawings. The invention is capable of other embodiments and of being practiced and carried out in various ways. The phraseology and terminology used herein are for the purpose of the description and should not be regarded as limiting.

To the accomplishment of the above and related objects, this invention may be embodied in the form illustrated in the accompanying drawings, attention being called to the fact, however, that the drawings are illustrative only, and that changes may be made in the specific construction illustrated.

### DETAILED DESCRIPTION OF INVENTION

The main components are held together with the sub components. This design is based on 25 years of masonry work.

The Kwik Leads comprises several pieces of various metals that are drilled, tapped and slotted, with a handle to hold the tool.

A 3″ by 0.500 by 1″ aluminum block which connects the scale to the adjustment bracket. 0.250 by 3.500″ by 7.250″ plate. 0.250 by 3.500 by 16.000″ plate.

3″ by 0.500 by 1″ aluminum block which connects the scale to the adjustment bracket. This block is drilled and tapped in two directions and is used to hold the tool together as well as to allow for adjustment.

0.250 by 3.500″ by 7.250″ plate. This bracket is used for maintaining the distance from the face of the brick to the face of the wall.

0.250 by 3.500 by 16.000″ plate. A flat plate with measurements stamped in various locations and used as the Masons Course Guide.

Handle is used to hold tool. The handle is a “U” shaped object fastened to the scale. It is used to hold and manipulate the tool in different directions.

In the process of brick laying all bricks must be put in place to form a described architecture. The bricks must be straight and uniform. Conventional methods of brick laying allows a certain amount of deviation which over a length of a wall could cause the structure to be several inches out of plum, thus being rejected by the contractors. This tool is used to ensure that each row of brick is exactly the same from the face of the brick to the face of the wall. The mason lays two to three bricks and uses the Kwik leads to ensure plumb. By holding the adjustment bracket against the existing wall, the bricks are checked for uniformity with the scale.

### BRIEF DESCRIPTION OF SEVERAL VIEWS OF DRAWINGS

FIG. 1 is BMS 001 A.0 A view of the assembly

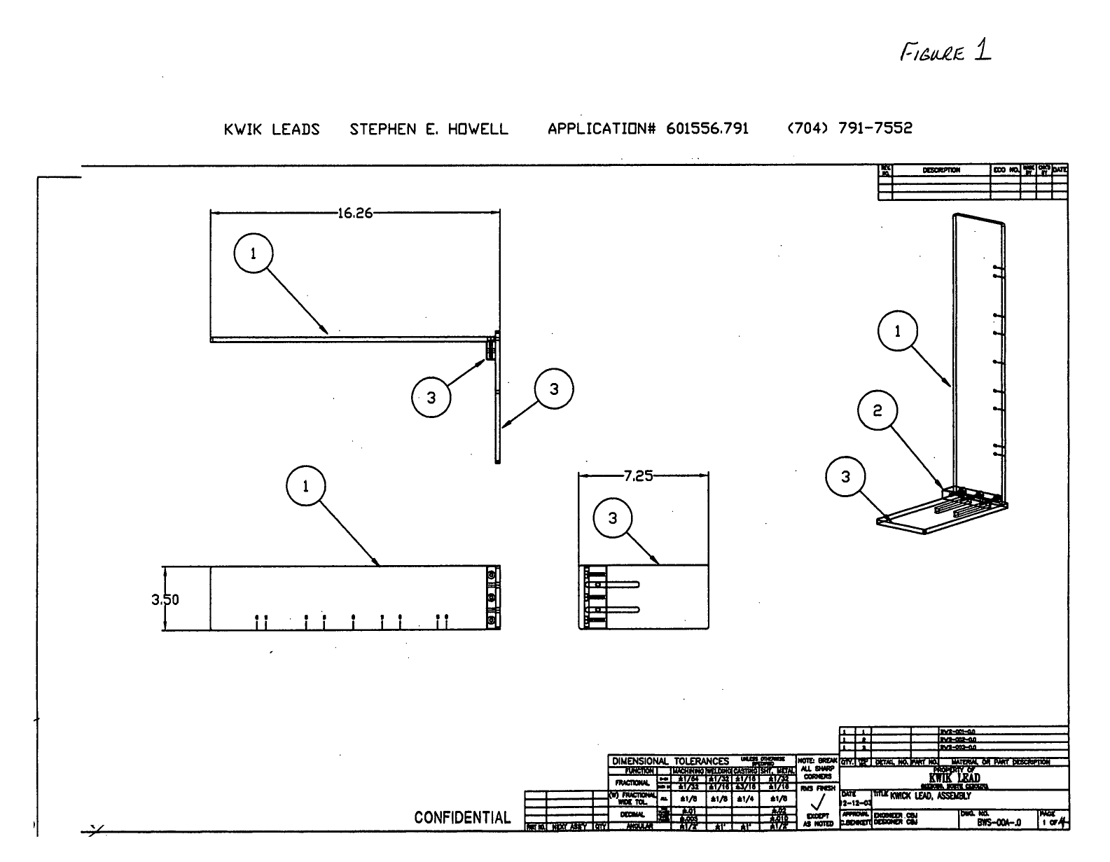

FIG. 2 is BMS 001 D.0 A view of the adjustment block

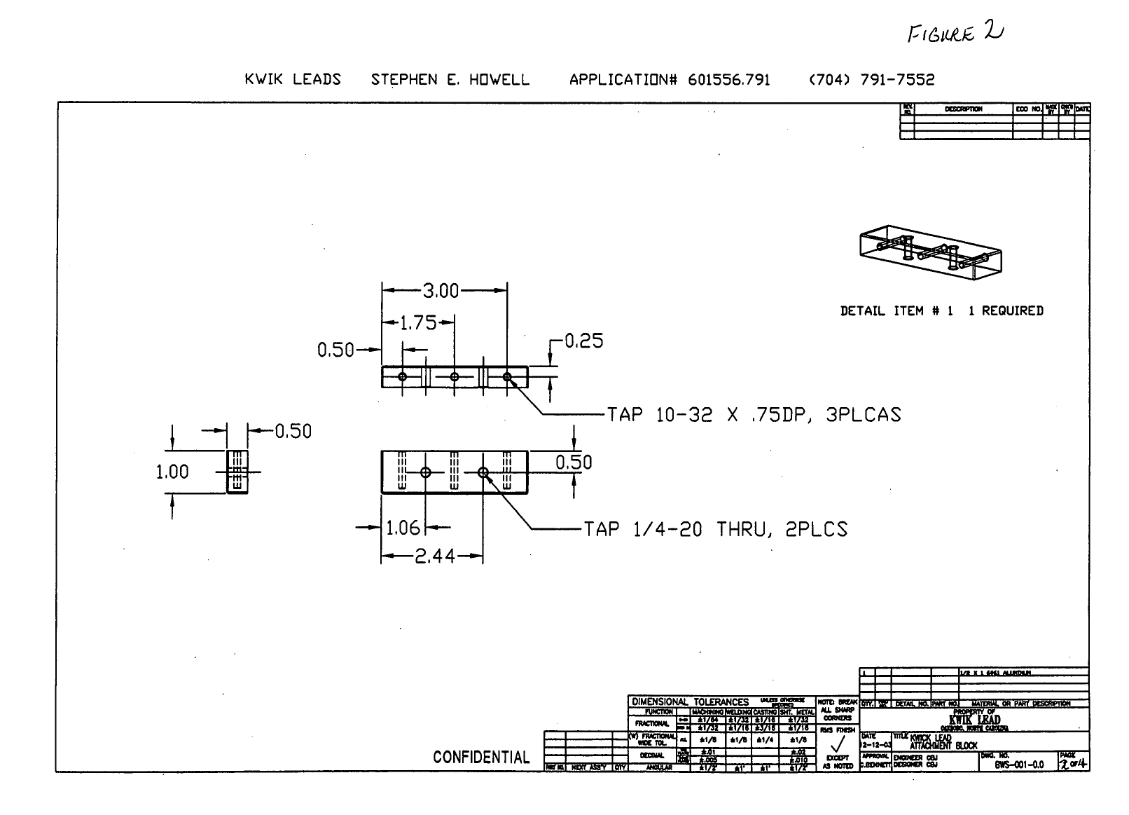

FIG. 3 is BMS 002 D.0 A view of the adjustment bracket

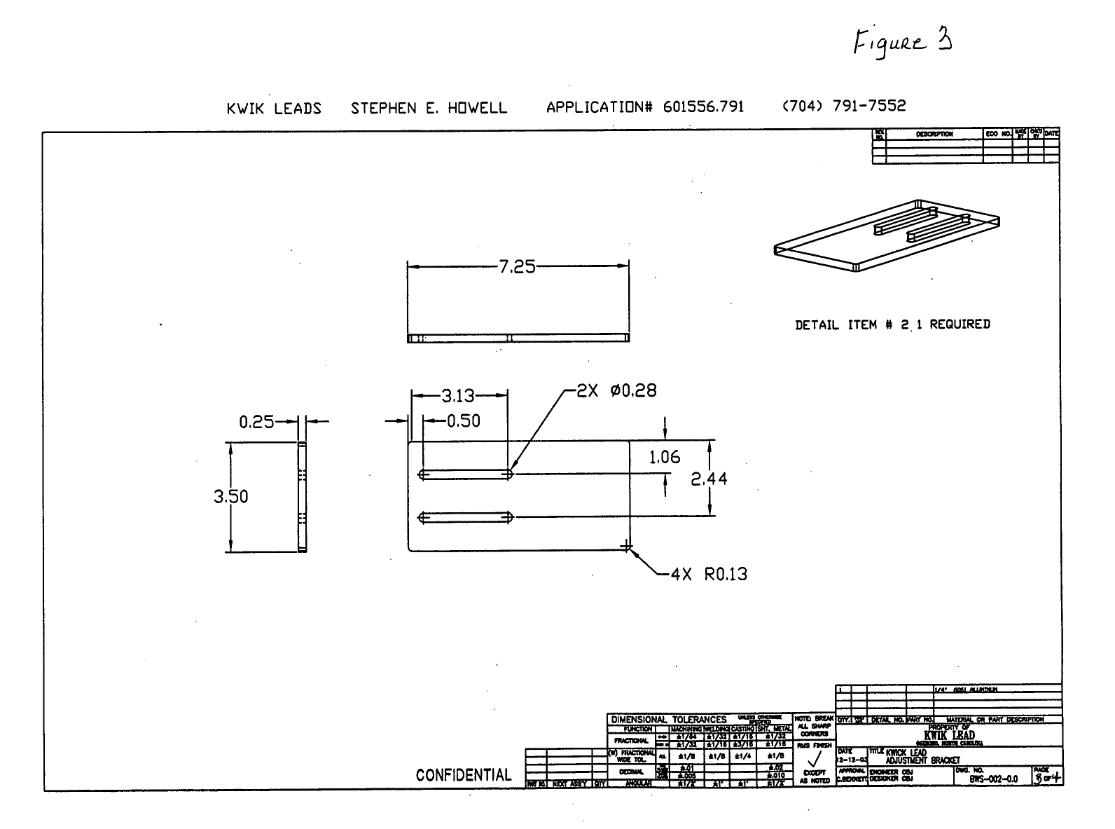

FIG. 4 is BMS 003 D.0 A view of the scale

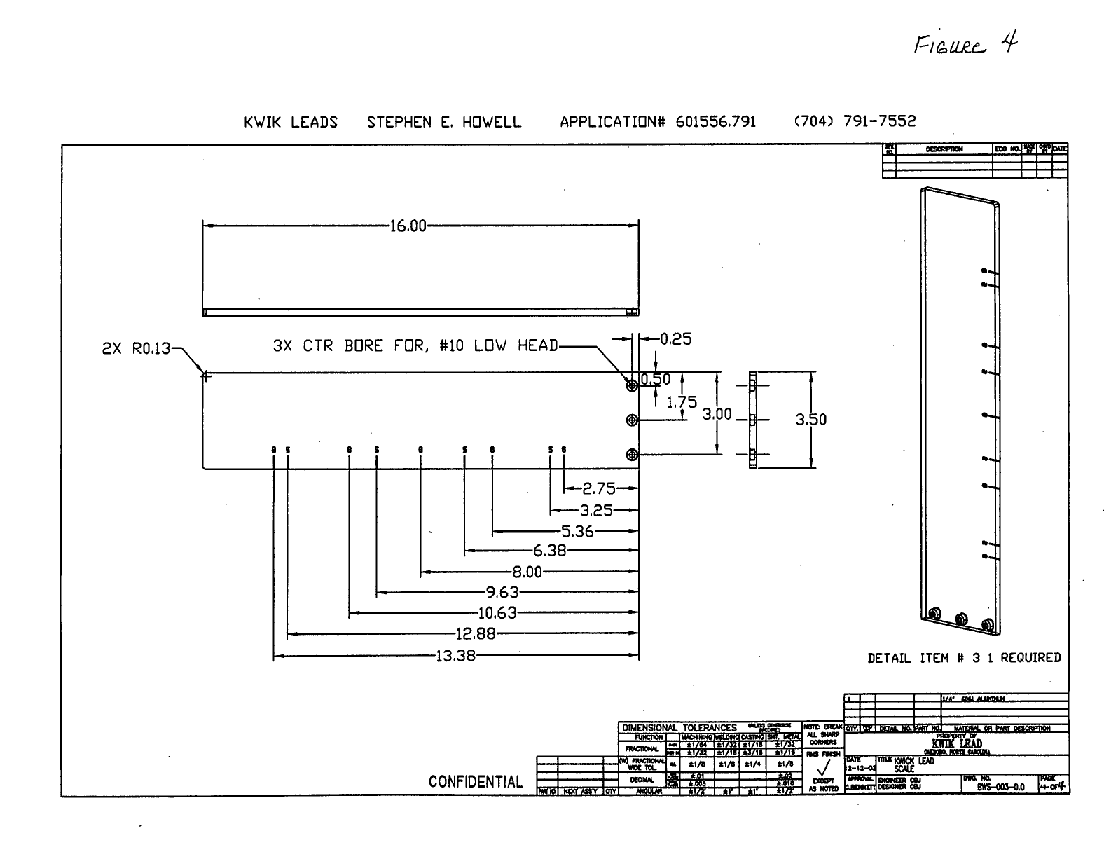

Black and White photo of Kwik Leads.

1. I claim the Kwik Leads is an aid for the ease of brick laying and improves the quality in the manufacture of homes and commercial buildings. The inventive device includes several pieces of various metals that are drilled, tapped and slotted. With a handle used to hold the tool. 3″ by 0.500 by 1″ aluminum block which connects the scale to the adjustment bracket. 0.250 By 3.500″ by 7.250 plate. 0.250 By 3.500 by 16.000″ Plate. Other objects and advantages of the present invention will become obvious to the reader and it is intended that these objects and advantages are within the scope of the present invention.
